(19) United States
(12) Patent Application Publication
(10) Pub. No.: US 2020/0245586 A1
(43) Pub. Date: Aug. 6, 2020

(54) DOG TOILET

(71) Applicant: UNICHARM Corporation, Ehime (JP)

(72) Inventors: Kenji Hiroshima, Kagawa (JP); Takayuki Matsuo, Kagawa (JP)

(73) Assignee: UNICHARM Corporation, Ehime (JP)

(21) Appl. No.: 16/852,818

(22) Filed: Apr. 20, 2020

Related U.S. Application Data
(63) Continuation of application No. PCT/JP2018/043013, filed on Nov. 21, 2018.

(30) Foreign Application Priority Data
Dec. 22, 2017 (JP) 2017-245892

(51) Int. Cl. A01K 1/01; A01K 5/02; A01K 29/00

(52) U.S. Cl. CPC A01K 1/01; A01K 29/005; A01K 5/02

(57) ABSTRACT

A dog toilet has a front-rear direction, a left-right direction, and an up-down direction that are perpendicular to one another. The dog toilet includes: a bottom portion; a urination detection sensor that detects whether there is urination by a dog; a wall portion provided to surround the bottom portion; an access opening provided in the wall portion on one side in the front-rear direction with respect to a front-rear-direction center position; and a feeder that supplies food from a feeding port based on a detection result of the urination detection sensor. The feeding port is provided on another side in the front-rear direction with respect to the front-rear-direction center position.

### CROSS-REFERENCE TO RELATED APPLICATIONS

This application is based on and claims priority under 35 U.S.C. § 119 to Japanese Patent Application No. 2017-245892 filed on Dec. 22, 2017, the contents of which are incorporated herein by reference.

### BACKGROUND

### Technical Field

The present invention generally relates to a dog toilet.

### Related Art

Conventionally, animal toilets used by animals such as pets (for example, dogs) are known. As animal toilets, there are also known toilets that give a stimulus (such as food, sound, or smell) when animals excrete in the toilets to train (toilet-train) the animals to spontaneously excrete in the toilets. For example, a toilet described in Patent Literature 1 includes: a urination detection sensor provided in a bottom portion; and a feeder that operates on the basis of a detection result of the urination detection sensor. When an animal excretes in the toilet, the urination detection sensor detects urine, and food is supplied from the feeder.

Patent Literature 1: Japanese Patent Application Publication No. 2009-45053

However, with the above-described animal toilet, it is difficult to toilet-train dogs to always excrete in the toilet. For example, there is a risk that dogs discharge residual urine in an area outside the toilet while eating supplied food and soil the area outside the toilet.

### SUMMARY

One or more embodiments provide a dog toilet capable of preventing an area outside a toilet from being soiled with urine.

A dog toilet according to one or more embodiments has a front-rear direction, a left-right direction, and an up-down direction that are perpendicular to one another.

The dog toilet includes:

a bottom portion;

a urination detection sensor capable of detecting whether there is urination by a dog;

a wall portion provided to surround the bottom portion;

an access opening provided in the wall portion on one side in the front-rear direction with respect to a front-rear-direction center position; and

a feeder configured to supply food from a feeding port based on a detection result of the urination detection sensor,
the feeding port being provided on another side in the front-rear direction with respect to the front-rear-direction center position.

One or more embodiments will become apparent from the following detailed description of exemplary embodiments with reference to the attached drawings.

According to one or more embodiments, it is possible to prevent an area outside a toilet from being soiled with urine.

### BRIEF DESCRIPTION OF THE DRAWINGS

FIG. 1 is a schematic perspective view of a dog toilet 10.

FIG. 2 is a plan view of the dog toilet 10 viewed from above.

FIG. 3 is a sectional view illustrating a configuration of a bottom portion 20.

FIG. 4A is a sectional view illustrating an arrangement of individual electrodes (a positive electrode 41 and a negative electrode 42) in the bottom portion 20.

FIG. 4B is a plan view of a portion around a grate 24 viewed from above.

FIG. 4C is a perspective view of FIG. 4B.

FIG. 4D is a sectional view.

FIG. 5 is a block diagram illustrating configurations of a urination detection sensor 40 and a feeder unit 50.

FIG. 6A is a schematic sectional view illustrating a configuration of a feeder 52.

FIG. 6B is a top view of a scale 110 illustrated in FIG. 6A.

FIG. 7 is a diagram illustrating a modification of the dog toilet 10.

FIG. 8 is an explanatory diagram illustrating an example of a case where a feeding plate 51 is not used.

FIG. 9 is an explanatory diagram illustrating another example of a case where the feeding plate 51 is not used.

### DETAILED DESCRIPTION

Embodiments of the present invention will be described herein with reference to the drawings. Those skilled in the art will recognize that many alternative embodiments can be accomplished using the teaching of the present invention and that the present invention is not limited to the embodiments illustrated herein for explanatory purposes.

A dog toilet has a front-rear direction, a left-right direction, and an up-down direction that are perpendicular to one another,

the dog toilet including:

a bottom portion;

a urination detection sensor capable of detecting whether there is urination by a dog;

a wall portion provided to surround the bottom portion;

an access opening provided in the wall portion on one side in the front-rear direction with respect to a front-rear-direction center position; and

a feeder configured to supply food from a feeding port based on a detection result of the urination detection sensor,
the feeding port being provided on another side in the front-rear direction with respect to the front-rear-direction center position.

With such a dog toilet, a dog which is eating food can stay away from the access opening. This makes it possible to prevent an area outside the toilet from being soiled with urine due to the dog discharging residual urine in the area outside the toilet while eating the food.

In such a dog toilet, the wall portion may be a continuous plate-shaped wall.

With such a dog toilet, it is possible to prevent food or urine from spilling to an area outside the toilet.

In such a dog toilet, the wall portion may include:
a first wall portion that is plate-shaped and is erected on the bottom portion, and
a second wall portion that is mesh-like and is provided above the first wall portion.

With such a dog toilet, it is possible to prevent food or urine from spilling to an area outside the toilet. In addition, a dog can have good visibility, making it more likely for the dog to excrete without any stress.

In such a dog toilet, the bottom portion may be provided with a continuous convex member that is arranged between an excretion area of the dog and a feeding area where the food is supplied.

With such a dog toilet, food supplied from the feeding port can be prevented from rolling out onto the excretion area or to an area outside the toilet.

In such a dog toilet, the bottom portion may be provided with a continuous concave groove that is formed between an excretion area of the dog and a feeding area where the food is supplied.

With such a dog toilet, food supplied from the feeding port can be prevented from rolling out onto the excretion area or to an area outside the toilet.

In such a dog toilet, a liquid-absorbent absorbent member that absorbs urine may be arranged in the bottom portion, and

an area of a portion of the absorbent member located on the other side in the front-rear direction is larger than an area of a portion of the absorbent member located on the one side in the front-rear direction.

With such a dog toilet, since there is a high possibility of a dog approaching the feeding port, there is a high possibility that the location of urination is on a feeding-port side. This makes it possible for an absorbent member to be arranged efficiently.

In such a dog toilet, the bottom portion may be provided with a protruding portion that surrounds the absorbent member.

With such a dog toilet, it is possible for the absorbent member to be secured against being moved even if a dog walks around in the toilet.

In such a dog toilet, the feeding port may be arranged in a corner portion, and

the corner portion may be constituted by a portion of the wall portion on the other side in the front-rear direction and a portion of the wall portion on either one of sides in the left-right direction.

With such a dog toilet, it is possible to ensure a wide excretion area in the toilet.

In such a dog toilet, the feeder may be provided outside the wall portion.

With such a dog toilet, it is possible to ensure a wide excretion area in the toilet. It is also possible to prevent a dog from eating food stored in the feeder.

In such a dog toilet, the access opening may be provided with a door, and

the door may be an automatically opening and closing door that opens after a predetermined period passes since the urination detection sensor detects urination by the dog.

With such a dog toilet, it is possible to make a dog stay in the toilet for a certain period after urination. Consequently, it is possible to prevent an area outside the toilet from being soiled with residual urine.

In such a dog toilet, the feeding port may be provided on one side in the left-right direction with respect to a left-right-direction center position, and

the access opening may be provided on another side in the left-right direction with respect to the left-right-direction center position.

With such a dog toilet, it is possible to delay a dog having eaten food from exiting to the outside of the toilet.

In such a dog toilet, the feeding port and the access opening may be provided on the same side in the left-right direction with respect to a left-right-direction center position.

With such a dog toilet, a dog is more likely to enter the toilet.

### Embodiments

### <Overall Configuration>

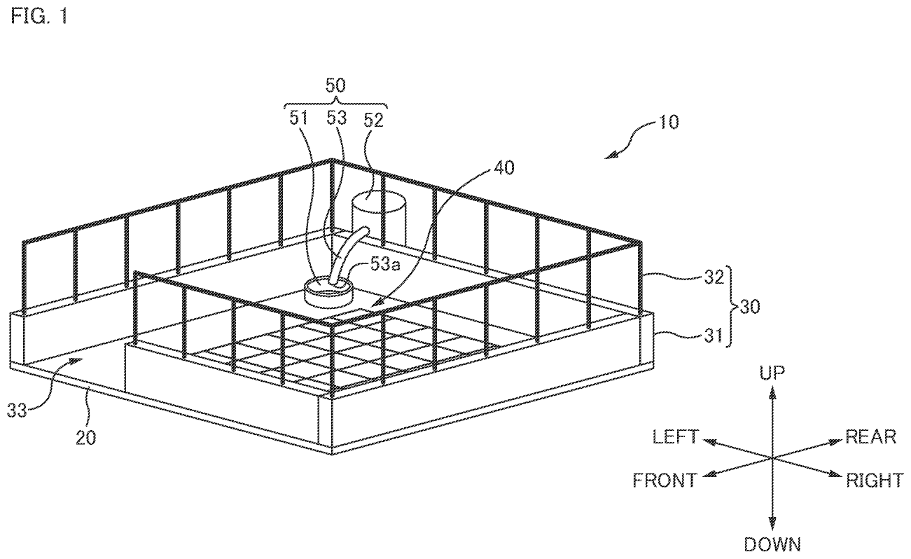

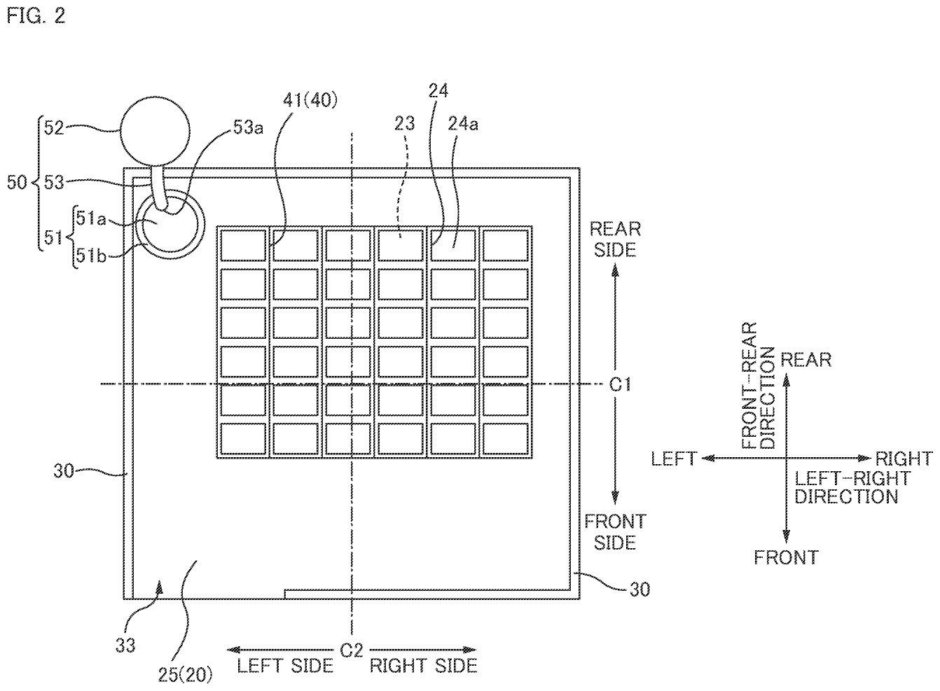

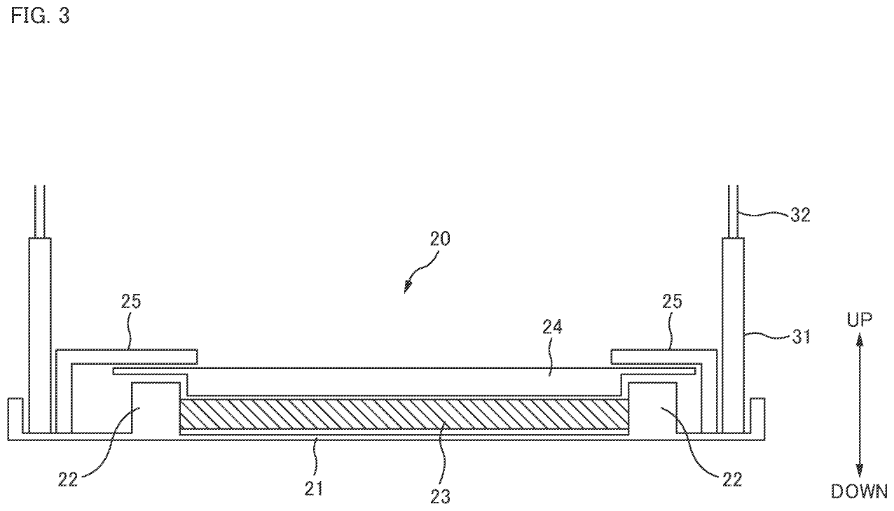

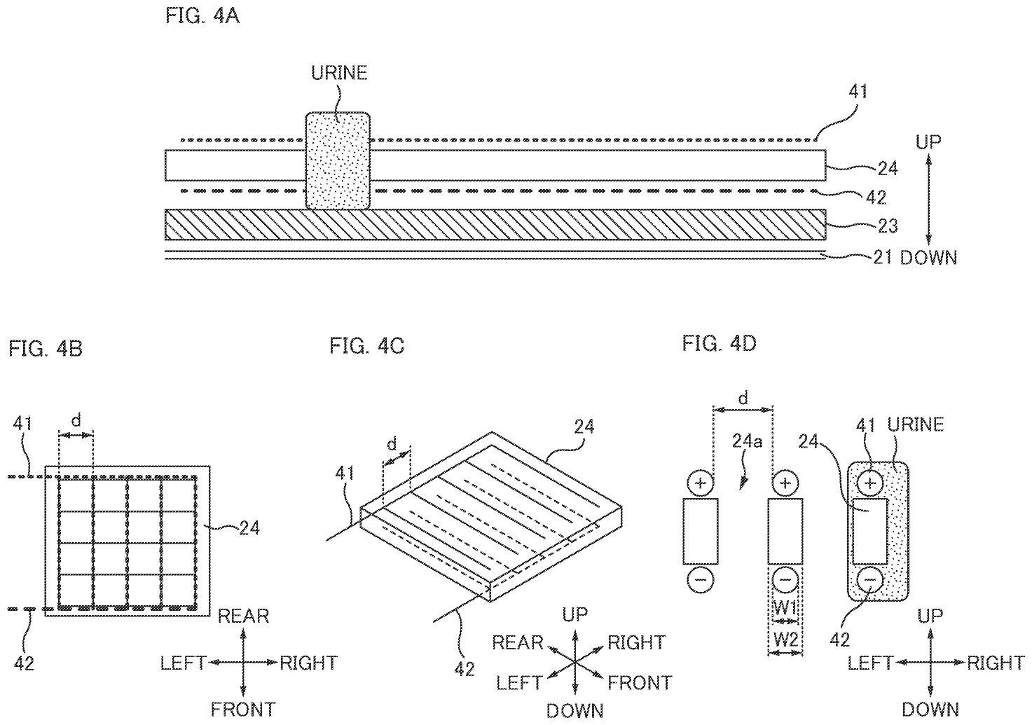

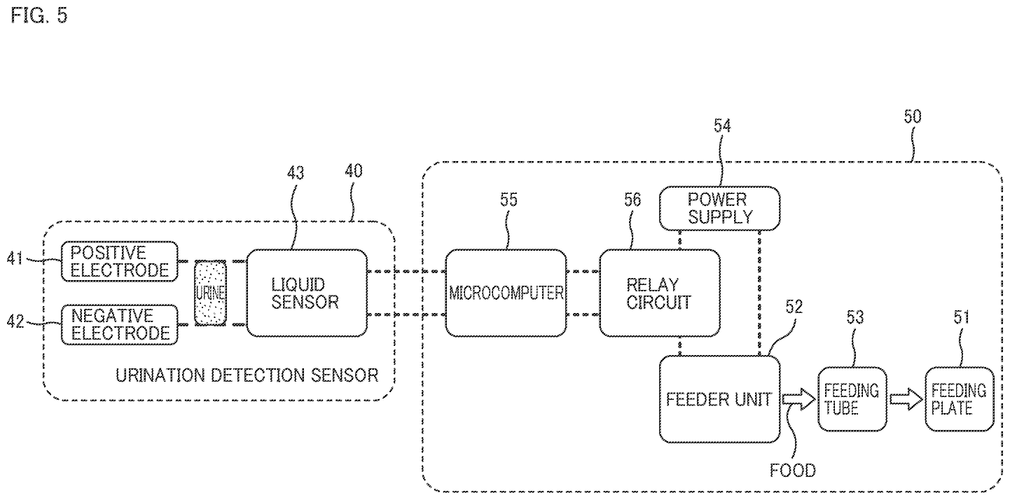

A dog toilet 10 will be described as an example of a dog toilet according to one or more embodiments. FIG. 1 is a schematic perspective view of the dog toilet 10. FIG. 2 is a plan view of the dog toilet 10 viewed from above. In addition, FIG. 3 is a sectional view illustrating an example of a configuration of a bottom portion 20. Further, FIG. 4A is a sectional view illustrating an arrangement of individual electrodes (a positive electrode 41 and a negative electrode 42) in the bottom portion 20. In addition, FIG. 4B is a plan view of a portion around a grate 24 viewed from above, FIG. 4C is a perspective view of FIG. 4B, and FIG. 4D is a sectional view. In FIG. 4C, apertures 24a of the grate 24 are omitted to clarify the arrangement of the individual electrodes, and viewable portions of the electrodes are denoted by solid lines and hidden portions of the electrodes are denoted by broken lines. Further, FIG. 5 is a block diagram illustrating configurations of a urination detection sensor 40 and a feeder unit 50.

The dog toilet 10 according to one or more embodiments is a toilet capable of being used for toilet-training a dog and is placed on the floor or the like for use. In the following description, “front-rear direction”, “left-right direction”, and “up-down direction”, which denote three directions perpendicular to one another, are defined as illustrated in FIG. 1. The up-down direction is the vertical direction. A placement surface (a bottom surface of a bottom-portion main body 21) side is denoted as “lower side”, and the opposite side is denoted as “upper side”. In addition, the front-rear direction and the left-right direction denote directions of a horizontal plane (horizontal direction). As illustrated in FIG. 2, a central position in the front-rear direction is denoted as a center position C1. A side where an access opening 33 is provided relative to the center position C1 is denoted as “front side”, and the opposite side is denoted as “rear side”. In addition, a central position in the left-right direction is denoted as a center position C2. A side where the access opening 33 is provided relative to the center position C2 is denoted as “left side”, and the opposite side is denoted as “right side”.

The dog toilet 10 includes the bottom portion 20, a wall portion 30, the urination detection sensor 40, and the feeder unit 50.

As illustrated in FIG. 1 and FIG. 2, the bottom portion 20 has a rectangular shape in plan view, and respective sides of the bottom portion 20 extend in the front-rear direction and the left-right direction. In addition, as illustrated in FIG. 3, the bottom portion 20 includes the bottom-portion main body 21, a protruding portion 22, an absorption sheet 23 (corresponding to an absorbent member), the grate 24 (corresponding to an insulating member and a liquid-permeable layer), and a cover 25.

The bottom-portion main body 21 is the lowest portion (base) of the bottom portion 20 and is a portion that constitutes a toilet structure. An area surrounded by the protruding portion 22 in the bottom-portion main body 21 (in other words, an area where the absorption sheet 23 is arranged) is an area where a dog excretes. In the following description, this area is also referred to as an excretion area.

The protruding portion 22 is a portion that protrudes upward from the bottom-portion main body 21 and is provided so as to surround the absorption sheet 23. The bottom-portion main body 21 is provided with the protruding portion 22 in this manner, and the absorption sheet 23 is arranged inside the protruding portion 22. Consequently, the absorption sheet 23 is less likely to be displaced (the absorption sheet 23 is less likely to be moved) even if the dog walks around, for example.

The absorption sheet 23 is a liquid-absorbent sheet member that absorbs urine or the like excreted by an animal (herein, a dog), and the absorption sheet 23 includes a liquid absorbent material (corresponding to an absorbent body) such as pulp fiber or superabsorbent polymer. In addition, in one or more embodiments, the absorption sheet 23 contains deodorant microcapsules and an antibacterial agent, masking the smell of absorbed urine and suppressing the propagation of bacteria from occurring. The absorption sheet 23 is arranged in the excretion area (the area surrounded by the protruding portion 22 in the bottom-portion main body 21). As a result of the absorption sheet 23 being arranged in the excretion area in this manner, urine is absorbed by the absorption sheet 23. This makes it possible to suppress erroneous operation of the urination detection sensor 40 and a feeder 52 due to dispersal of urine caused by vibration that occurs when the dog moves around wildly, for example.

In one or more embodiments, the absorption sheet 23 (as well as the grate 24) is arranged to be lopsided with respect to the center position C1 in the front-rear direction. For example, the absorption sheet 23 is arranged such that the area of a portion on the rear side with respect to the center position C1 is larger than the area of a portion on the front side with respect to the center position C1 (see FIG. 2). This is because the possibility of the dog approaching a feeding plate 51 is high because of the smell of food remaining in the feeding plate 51 when the dog enters the dog toilet 10, and therefore the possibility of the dog urinating on the rear side relative to the center position C1 is high. Thus, making the area of the rear-side (feeding-plate-51-side) portion larger than the area of the front-side (access-opening-33-side) portion relative to the center position C1 makes it possible for the absorption sheet 23 to be arranged efficiently.

The grate 24 is arranged so as to cover the absorption sheet 23 (that is, in the excretion area). The grate 24 has the plurality of apertures 24a penetrating in the up-down direction and enables urine or the like excreted by the dog to pass through the apertures 24a from the upper side to the lower side (toward the absorption sheet 23) in the up-down direction. That is, the grate 24 corresponds to a liquid-permeable layer. The grate 24 according to one or more embodiments is formed into a rectangular grating shape, and the apertures 24a each have a rectangular shape in plan view. However, the configuration is not limited to this, and a grate having circular or hexagonal apertures may be used. As described later, the positive electrode 41 and the negative electrode 42 of the urination detection sensor 40 are arranged on the grate 24.

As a material of the grate 24, an insulator, for example, a non-liquid-absorbent insulator that does not absorb liquid (for example, polypropylene, silicone, or the like) is used. This is because, if an absorbent insulator (for example, sponge) is used, the insulator absorbs urine. The absorbed urine causes the positive electrode 41 and the negative electrode 42 to continue conducting electricity, which hinders accurate determination. That the grate 24 is composed of a non-liquid-absorbent insulator makes it less likely for the grate 24 to hold urine. This makes it possible to prevent the positive electrode 41 and the negative electrode 42 from continuing conducting electricity. In addition, as the material of the grate 24, a hydrophobic material having a surface that increases surface tension may be used.

The cover 25 is attached above the bottom-portion main body 21 and covers the bottom-portion main body 21 and the protruding portion 22. In addition, the cover 25 has an opening in a portion corresponding to the position where the absorption sheet 23 is arranged (the excretion area). Consequently, the cover 25 constitutes an upper surface of the bottom portion 20 except for the excretion area. In addition, the grate 24 is suspended on the cover 25 in such a manner to move in the up-down direction.

The wall portion 30 is provided so as to surround the four sides of the bottom portion 20 (in the front-rear direction and the left-right direction). In the following description, an inner side of the wall portion 30 is also referred to as inside the toilet. The wall portion according to one or more embodiments includes a plate wall 31 (corresponding to a first wall portion), a fence 32 (corresponding to a second wall portion), and the access opening 33.

The plate wall 31 is a plate-shaped wall that is continuous and is erected on the bottom portion 20. The plate wall 31 illustrated in FIG. 3 has side faces that are perpendicular to the horizontal plane and that have a constant thickness irrespective of the position in the up-down direction. However, the configuration of the plate wall 31 is not limited to this. For example, the plate wall 31 may be an inclined surface having a thickness that decreases from the lower side to the upper side in the up-down direction. Conversely, the plate wall 31 may be an inclined surface having a thickness that increases from the lower side to the upper side in the up-down direction.

The fence 32 is a mesh-like barrier having voids and is provided above the plate wall 31.

Thus, the wall portion 30 of the dog toilet 10 according to one or more embodiments has a combined configuration of the plate wall 31 and the fence 32. The plate wall 31 constitutes the lower portion of the wall portion 30, and this ensures that food or urine of the dog are less likely to spill to an area outside the toilet. In addition, the fence 32 constitutes the upper portion of the wall portion 30, and this enables the dog to have good visibility, making it more likely for the dog to urinate in the toilet without any stress. In addition, a feeding tube 53 is easily drawn through the wall portion 30 to the inner side of the wall portion 30. As materials of the plate wall 31 and the fence 32, any material, such as metal, plastic, or wood, may be used.

The access opening 33 is a portion where the dog enters and exits the toilet (the inner side of the wall portion 30) and is formed at the left end of a portion (front-side portion) of the wall portion 30 that demarcates the front side of the bottom portion 20. That is, the access opening 33 is provided on the front side relative to the center position C1 in the front-rear direction and on the left side relative to the center position C2 in the left-right direction. The access opening 33 according to one or more embodiments is formed by making an opening at the above-described portion of the wall portion 30 (the plate wall 31 and the fence 32) surrounding the bottom portion 20 (making the above-described portion discontinuous).

The urination detection sensor 40 is a sensor that detects whether there is urination by a dog (for example, the presence of liquid). The urination detection sensor 40 includes the positive electrode 41, the negative electrode 42, and a liquid sensor 43.

As illustrated in FIG. 4A and FIG. 4D, the positive electrode 41 is arranged on (the upper surface of) the grate 24. As a material of the positive electrode 41, a material having high conductivity (for example, copper or rust-resistant stainless steel) may be used.

The negative electrode 42 is also formed of a material having high conductivity, similarly to the positive electrode 41, and is arranged under (on the lower surface of) the grate 24.

Thus, the positive electrode 41 and the negative electrode 42 are provided on the grate 24 that covers the absorption sheet 23. This make urine be quickly absorbed by the absorption sheet 23, making it possible to reduce the amount of urine that remains on the electrodes. Consequently, it is possible to correctly detect the urination timing.

In FIG. 4A, in order to clarify the arrangement, the grate 24 and the individual electrodes (the positive electrode 41 and the negative electrode 42), and the negative electrode 42 and the absorption sheet 23 are illustrated as spaced apart from each other. However, they are actually in contact with each other. By keeping the negative electrode 42 in contact with the absorption sheet 23, urine adhered to the negative electrode 42 can be absorbed by the absorption sheet 23. This can suppress, for example, the occurrence of the smell of urine. Since the grate 24 is suspended on the cover 25 to be vertically movable as described above, the negative electrode 42 is vertically movable together with the grate 24 even if the absorption sheet 23 expands due to absorbing urine.

As illustrated in FIG. 4C, the positive electrode 41 is divided into a plurality of branches on the grate 24, and the plurality of branches are linearly arranged extending along the front-rear direction with spaces therebetween in the left-right direction to be parallel to one another. In addition, the negative electrode 42 is also divided into a plurality of branches on the grate 24, and the plurality of branches are linearly arranged extending along the front-rear direction with spaces therebetween in the left-right direction to be parallel to one another (to form pairs with the positive electrode 41). A plurality of pairs of the positive electrode 41 and the negative electrode 42 are arranged side-by-side in the horizontal direction (the left-right direction). Consequently, the electrodes can be arranged densely, making it possible to increase the accuracy of the urination detection sensor 40. The positive electrode 41 and the negative electrode 42 forming a pair are spaced apart in the up-down direction and superpose in terms of position in the horizontal direction (the left-right direction herein).

Although the positive electrode 41 is arranged on the grate 24 and the negative electrode 42 is arranged under the grate 24 according to one or more embodiments, the arrangement may be reversed. That is, the negative electrode 42 may be arranged on the grate 24 and the positive electrode 41 may be arranged under the grate 24. In addition, although each of the positive electrode 41 and the negative electrode 42 that constitute a pair is linearly arranged along the front-rear direction according to one or more embodiments, the arrangement is not limited to this. For example, each of the positive electrode 41 and the negative electrode 42 may be arranged in the left-right direction. In addition, each of the positive electrode 41 and the negative electrode 42 may be arranged to be bent in a zigzag shape on the horizontal plane in accordance with the shape of the grate 24. A distance d between the electrodes that are adjacent to each other in the horizontal direction may be arbitrary. However, since urine needs at least to be directly in contact with the electrodes, the distance may be 5 cm or less. In addition, if the distance is too short, it is difficult to remove feces soiling. Therefore, the distance may be 1 cm or greater.

In addition, a width W2 of the grate 24 illustrated in FIG. 4D is greater than a width W1 of the positive electrode 41 and the negative electrode 42. This is because, if the width W2 of the grate 24 is less than the width W1 of the positive electrode 41 and the negative electrode 42, there is a risk that urine remains on a side wall of the grate 24 owing to surface tension of the urine and the conducting state continues, and decreases the accuracy of the urination detection sensor 40. According to one or more embodiments, the width W2 of the grate 24 is set greater than the width W1 of the positive electrode 41 and the negative electrode 42. Thus, urine covering a portion between a pair of the positive electrode 41 and the negative electrode 42 is more likely to undergo fluid thread breakup, making it possible to increase the accuracy of the urination detection sensor 40.

The liquid sensor 43 amplifies an electric signal (voltage) when the positive electrode 41 and the negative electrode 42 conduct electricity, and outputs the amplified signal to a microcomputer 55. According to one or more embodiments, a method for controlling the liquid sensor 43 (and the microcomputer 55 described later) involves analog control using an analog voltage value. However, the control method is not limited to this, and digital control using H (high)/L (low) digital signals may be used.

When a dog urinates above the grate 24, urine passes through the positive electrode 41, the grate 24 (the apertures 24a), and the negative electrode 42 and is absorbed by the absorption sheet 23 as illustrated in FIG. 4A. At this time, the positive electrode 41 and the negative electrode 42 conduct electricity through the urine as illustrated in FIG. 4A and FIG. 4D, and an output voltage of the liquid sensor 43 rises. After the dog finishes urinating, an electrical conductor no longer exists between the positive electrode 41 and the negative electrode 42 because the grate 24 is a non-liquid-absorbent insulator. Therefore, the negative electrode 42 and the positive electrode 41 no longer conduct electricity (enters non-conducting state), decreasing the output voltage of the liquid sensor 43.

As illustrated in FIG. 5, the feeder unit 50 includes the feeding plate 51, the feeder 52, the feeding tube 53, a power supply 54, the microcomputer 55, and a relay circuit 56.

The feeding plate 51 is a container in which dog food is held. The feeding plate 51 includes a bottom wall 51a having a circular shape in plan view, and a peripheral side wall 51b that is erected upward on the periphery of the bottom wall 51a. According to one or more embodiments, the bottom wall 51a of the feeding plate 51 corresponds to a feeding area, and the peripheral side wall 51b corresponds to a convex member. As a result of the feeding plate 51 including the peripheral side wall 51b, food supplied from a feeding port 53a (described later) of the feeding tube 53 is prevented from rolling out onto the excretion area. Food is stored in a food container 100 (described later) of the feeder 52 and is supplied to the feeding plate 51 from the feeder 52 through the feeding tube 53.

As illustrated in FIG. 1 and FIG. 2, the feeding plate 51 (in other words, the feeding port 53a) is arranged in a corner portion (that is, a corner portion on a left rear side in the wall portion 30), and this corner portion is formed by a portion of the wall portion 30 on the rear side in the front-rear direction and a portion of the wall portion 30 on the left side in the left-right direction. This can ensure a wide space (excretion area) in the toilet.

The feeder 52 is an electrically powered apparatus (feeder) that automatically supplies food on the basis of a detection result of the urination detection sensor 40. The feeding tube 53 is attached to the feeder 52. The feeder 52 is arranged outside the wall portion 30, and that the feeding tube 53 attached to the feeder 52 is drawn to the inner side of the wall portion 30 through the fence 32. The configuration of the feeder 52 will be described later.

The feeding tube 53 is a hollow tubular member (for example, a tube) for supplying food ejected from the feeder 52 to the feeding plate 51, and the feeding tube 53 has the feeding port 53a. The feeding port 53a is an outlet of the feeding tube 53 and is arranged above the feeding plate 51 in the toilet. That is, the feeding port 53a is arranged on the rear side relative to the center position C1 in the front-rear direction. As described above, according to one or more embodiments, the feeding plate 51 is arranged on the rear side in the front-rear direction and the access opening 33 is provided in the wall portion 30 on the front side in the front-rear direction. If the positions of the feeding port 53a and the access opening 33 are close to each other, there is a risk that the dog discharge residual urine in an area outside the toilet while eating food. According to one or more embodiments, the positions of the feeding port 53a and the access opening 33 are apart from each other. This makes it possible for the dog which is eating food to stay in the toilet after urination, making it possible to prevent an area outside the toilet from being soiled with urine.

The power supply 54 supplies electric power to each of the components (the feeder 52, the microcomputer 55, and the relay circuit 56) of the feeder unit 50.

The output of the urination detection sensor 40 (the liquid sensor 43) is input to the microcomputer 55. The microcomputer 55 performs control described below, in accordance with a change in voltage of the urination detection sensor 40. That is, when the voltage falls below a predetermined voltage (because the positive electrode 41 and the negative electrode 42 stop conducting electricity) after the voltage rises (because the positive electrode 41 and the negative electrode 42 conduct electricity), the microcomputer 55 causes the relay circuit 56 to operate.

In accordance with the output of the microcomputer 55, the relay circuit 56 operates (is active) for a certain period according to controlling of the time in seconds, and thereby the relay circuit 56 causes the feeder 52 to operate (for example, a motor 120 described later is driven to rotate a rotational body 111). Consequently, food is supplied from the feeder 52.

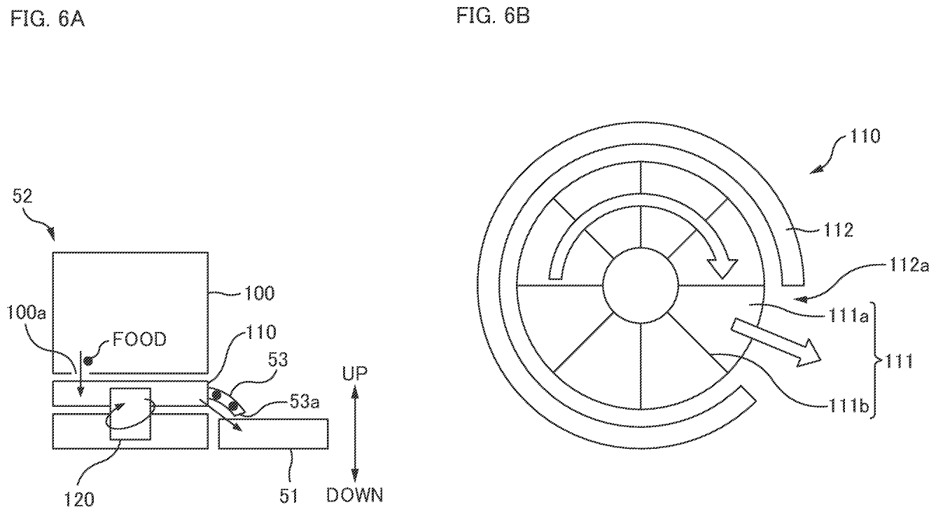

FIG. 6A is a schematic sectional view illustrating an example of a configuration of the feeder 52, and FIG. 6B is a top view of a scale 110 illustrated in FIG. 6A.

The feeder 52 includes the food container 100, the scale 110, and the motor 120.

The food container 100 is a hollow cylindrical member provided in an upper portion of the feeder 52 and stores dog food therein. In addition, a through hole 100a is provided in a bottom portion of the food container 100, so that food drops from the through hole 100a due to its weight.

The scale 110 is a weigh scale arranged under the food container 100 and includes the rotational body 111 and a periphery wall portion 112.

The rotational body 111 includes a bottom portion 111a and a plurality of partition plates 111b.

The bottom portion 111a is a plate-shaped member having a circular shape in plan view. An upper surface of the bottom portion 111a is an inclined surface where the height of an outer portion is lower than the height of the center position.

The partition plates 111b are provided on the upper surface of the bottom portion 111a. The plurality of partition plates 111b are provided radially at an equal interval, with respect to an axis located at the center of the bottom portion 111a. Consequently, the partition plates 111b partition a space above the bottom portion 111a into a plurality of spaces.

The periphery wall portion 112 is provided to surround the outer side of the rotational body 111. An opening 112a is formed in the periphery wall portion 112 at a position corresponding to one of partitioned portions formed by the partition plates 111b. In addition, outside the opening 112a, the feeding tube 53 is arranged. Food ejected from the opening 112a is supplied to the feeding plate 51 through the feeding tube 53.

The motor 120 is driven in accordance with the output of the relay circuit 56, rotating the rotational body 111 of the scale 110. That is, the motor 120 rotates the rotational body 111 in a circumferential direction around the axis located at the center of the rotational body 111.

Operation of the urination detection sensor 40 and the feeder unit 50 will be described below.

When a dog urinates above the grate 24 and urine reaches the positive electrode 41 and the negative electrode 42 of the urination detection sensor 40, the positive electrode 41 and the negative electrode 42 conduct electricity through the urine, which is an electrical conductor. The conducted voltage is amplified by the liquid sensor 43 and is sent to the microcomputer 55. When the output of the urination detection sensor 40 (the liquid sensor 43) falls below a predetermined voltage as a result of the dog finishing urinating, the microcomputer 55 causes the relay circuit 56 to operate for a certain period. Consequently, the motor 120 of the feeder 52 is driven to rotate the rotational body 111 of the scale 110 by a certain amount. As a result of the rotational body 111 rotating, food located between the adjacent partition plates 111b of the scale 110 is ejected from the opening 112a of the periphery wall portion 112 and is supplied to the feeding plate 51 through the feeding tube 53. In this manner, food is automatically supplied in response to urination by the dog. In addition, food stored in the food container 100 is dropped through the through hole 100a to the scale 110 located below (to a portion which has become empty as a result of food having ejected from the opening 112a).

As described above, the wall portion 30 is provided to surround the bottom portion 20 in the dog toilet 10 according to one or more embodiments. Thus, a position where the dog excretes is limited to being within the wall portion 30 (inside the toilet). Further, the access opening 33 for a dog is provided on the front side relative to the center position C1 in the front-rear direction, and the feeding port 53a of food is provided on the rear side relative to the center position C1 in the front-rear direction. This can delay the time for the dog that eats the supplied food exits to the outside of the wall portion 30 (outside the toilet) and can prevent an area outside the toilet from being soiled with residual urine or the like.

### [Modification]

In the embodiments described above, both the feeding plate 51 (in other words, the feeding port 53a) and the access opening 33 are provided on the same side (on the left side) relative to the center position C2 in the left-right direction. However, the arrangement is not limited to this.

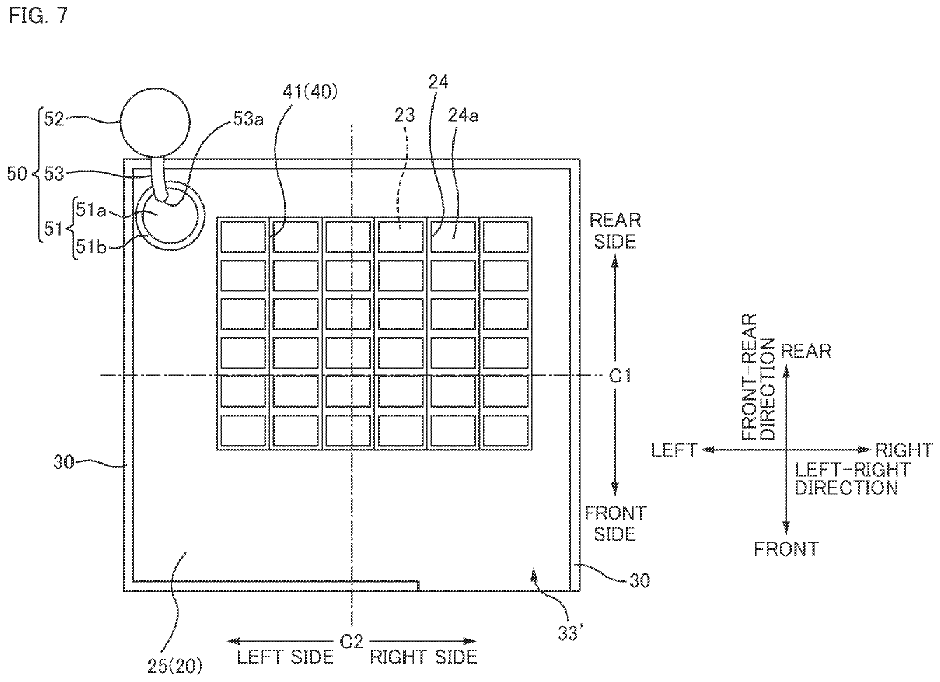

FIG. 7 is a diagram illustrating a modification of the dog toilet 10. In the figure, the same components as in FIG. 2 are denoted by the same references to omit description thereof.

In this modification, an access opening 33′ is provided. The access opening 33′ is provided on a right side of the front portion of the wall portion 30 (on the right side relative to the center position C2 in the left-right direction). The feeding port 53a and the access opening 33′ are arranged at diagonal positions. In this case, it is possible to delay the dog from reaching the access opening after eating the food. On the other hand, when the access opening 33 and the feeding port 53a are arranged on the same side relative to the center position C2 in the left-right direction as illustrated in FIG. 2, the dog is more likely to enter the toilet.

### Other Embodiments

Although the embodiments of the present disclosure have been described hereinabove, the above embodiments of the present disclosure are simply to facilitate understanding of the present disclosure and are not in any way to be construed as limiting the present disclosure. The present disclosure may variously be changed or altered without departing from its gist and encompass equivalents thereof. For example, modification which will be described below is possible.

### [Wall Portion 30]

In the embodiments described above, the wall portion 30 is constituted by the plate wall 31 and the fence 32. However, the configuration is not limited to this. For example, the wall portion 30 may be constituted only by the plate wall 31 that is continuous and plate-shaped. In this case, it is possible to more reliably prevent food or urine of a dog from spilling to an area outside the toilet. For example, if the dog urinates while raising a leg, it is possible to prevent urine from spilling to an area outside the toilet. It is also possible to prevent urine from reaching the excretion area when the dog urinates toward the toilet from outside the toilet (prevent the urination detection sensor 40 from detecting urination erroneously). In this case, an access opening may be provided by removing a portion of the plate wall 31.

In addition, the wall portion 30 may be constituted only by the fence 32. Further, the mesh-like shape of the fence 32 is not limited to the one illustrated in FIG. 1 and may be any shape. In addition, the bottom portion 20 may have a wall as the circumference thereof rises upward to have a wall shape.

### [Feeding Plate 51]

In the embodiments described above, food is supplied to the feeding plate 51. However, the configuration is not limited to this. For example, food may be scattered on the bottom portion 20. In this case, however, food may roll out onto the excretion area, which is hygienically unpreferable. Therefore, a configuration for preventing food from rolling out onto the excretion area may be made as described below.

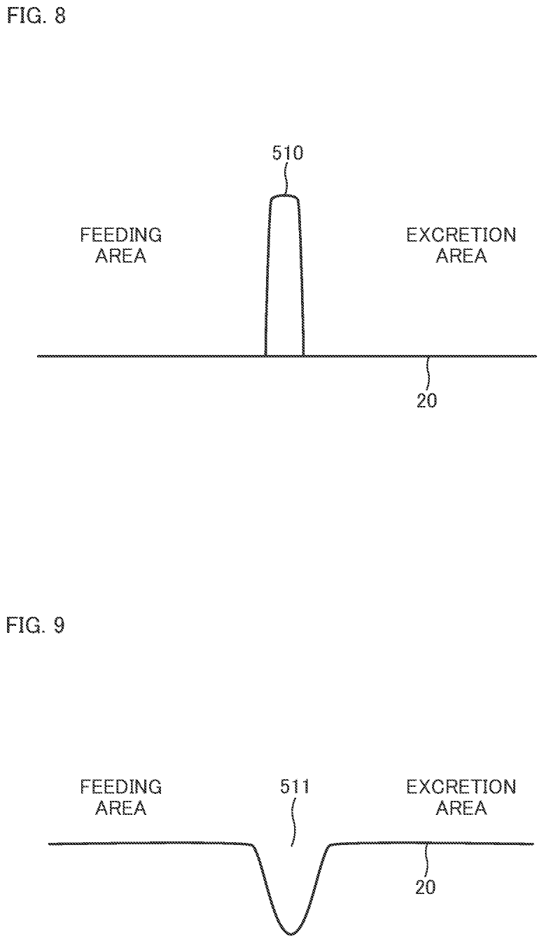

FIG. 8 is an explanatory diagram illustrating an example of a case where the feeding plate 51 is not used.

In FIG. 8, the bottom portion 20 is provided with a convex member 510 that protrudes upward. The convex member 510 is provided continuously between the feeding area and the excretion area. Also in the case where the continuous convex member 510 is provided between the feeding area and the excretion area in this manner, it is possible to prevent food from rolling out onto the excretion area. The feeding area is fixed in this case. In contrast, in the case where the feeding plate 51 is used, the feeding area can be moved appropriately.

FIG. 9 is an explanatory diagram illustrating another example of a case where the feeding plate 51 is not used.

In FIG. 9, a groove portion 511 that is concave downward is formed in the bottom portion 20. The groove portion 511 is provided continuously between the feeding area and the excretion area. Also in the case where the continuous groove portion 511 is provided between the feeding area and the excretion area in this manner, it is possible to prevent food from rolling out onto the excretion area. Note also that in this case, the feeding area is fixed.

### [Feeder 52]

In the embodiments described above, the feeder 52 is arranged outside the wall portion 30. However, the arrangement is not limited to this and the feeder 52 may be arranged within the wall portion 30. However, if the feeder 52 is arranged outside the wall portion 30, it is possible to widen an area in the toilet (excretion area). In addition, it is possible to prevent the dog from eating food stored in the feeder 52 (specifically, the food container 100).

In addition, the feeder 52 is not limited to the one described above, and may have any size and any configuration.

### [Access Opening 33]

In the embodiments described above, the access opening 33 is formed by making an opening at a portion of the wall portion 30. However, the configuration is not limited to this. For example, a slidable door may be provided. In this case, an automatic door that allows a dog to enter and exit by itself may be used. In addition, in this case, when a door that opens after a certain period passes since detection of urine is used, it is possible to make the dog stay in the toilet for a while after urination. Therefore, it is possible to prevent an area outside the toilet from being soiled with residual urine or the like.

### [Urination Detection Sensor 40]

In the embodiments described above, the urination detection sensor 40 is a sensor that detects whether there is urination on the basis of whether there is conduction of electricity between the positive electrode 41 and the negative electrode 42. However, the urination detection sensor 40 is not limited to this and may be a sensor of another type. For example, a light-emitting unit and a light-receiving unit of an infrared sensor may be provided respectively on one side and the other side of the urination area in the left-right direction (or the front-rear direction). It is also possible to determine whether there is urination in this case depending on whether infrared radiation is blocked by urine.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

10 dog toilet,
20 bottom portion, 21 bottom-portion main body,
22 protruding portion, 23 absorption sheet (absorbent member),
24 grate, 24a aperture,
25 cover,
30 wall portion,
31 plate wall (first wall portion),
32 fence (second wall portion),
33 access opening,
40 urination detection sensor,
41 positive electrode,
42 negative electrode,
43 liquid sensor,
50 feeder unit,
51 feeding plate,
51a bottom wall (feeding area), 51b peripheral side wall (convex member),
52 feeder,
53 feeding tube, 53a feeding port,
54 power supply,
55 microcomputer,
56 relay circuit,
100 food container,
100a through hole,
110 scale, 111 rotational body,
111a bottom portion, 111b partition plate,
112 periphery wall portion,
112a opening,
120 motor,
510 convex member,
511 groove portion,
C1 center position,
C2 center position (left-right center position)

What is claimed is:

1. A dog toilet having a front-rear direction, a left-right direction, and an up-down direction that are perpendicular to one another, the dog toilet comprising:
a bottom portion;
a urination detection sensor that detects whether there is urination by a dog;
a wall portion that surrounds the bottom portion;
an access opening in the wall portion on one side in the front-rear direction with respect to a front-rear-direction center position; and
a feeder that supplies food from a feeding port based on a detection result of the urination detection sensor, wherein
the feeding port is on another side in the front-rear direction with respect to the front-rear-direction center position.

2. The dog toilet according to claim 1, wherein the wall portion is a continuous plate-shaped wall.

3. The dog toilet according to claim 1, wherein
the wall portion comprises:
a first wall portion that is plate-shaped and is erected on the bottom portion, and
a second wall portion that is mesh-like and is above the first wall portion.

4. The dog toilet according to claim 1, wherein in the bottom portion, a continuous convex member is between an excretion area of the dog and a feeding area where the food is supplied.

5. The dog toilet according to claim 1, wherein in the bottom portion, a continuous concave groove is between an excretion area of the dog and a feeding area where the food is supplied.

6. The dog toilet according to claim 1, wherein
a liquid-absorbent absorbent member that absorbs urine is in the bottom portion, and
a first area of a portion of the absorbent member on the another side is larger than an area of a portion of the absorbent member on the one side in the front-rear direction.

7. The dog toilet according to claim 6, wherein the bottom portion comprises a protruding portion that surrounds the absorbent member.

8. The dog toilet according to claim 1, wherein
the feeding port is in a corner portion, and
the corner portion is constituted by a portion of the wall portion on the other side in the front-rear direction and a portion of the wall portion on either one of sides in the left-right direction.

9. The dog toilet according to claim 1, wherein the feeder is outside the wall portion.

10. The dog toilet according to claim 1, wherein
the access opening comprises a door, and
the door is an automatically opening and closing door that opens after a predetermined period has passed since the urination detection sensor detects urination by the dog.

11. The dog toilet according to claim 1, wherein
the feeding port is on one side in the left-right direction with respect to a left-right-direction center position, and
the access opening is on another side in the left-right direction with respect to the left-right-direction center position.

12. The dog toilet according to claim 1, wherein the feeding port and the access opening are on a same side in the left-right direction with respect to a left-right-direction center position.

13. The dog toilet according to claim 2, wherein in the bottom portion, a continuous convex member is between an excretion area of the dog and a feeding area where the food is supplied.

14. The dog toilet according to claim 3, wherein in the bottom portion, a continuous convex member is between an excretion area of the dog and a feeding area where the food is supplied.

15. The dog toilet according to claim 2, wherein in the bottom portion, a continuous concave groove is between an excretion area of the dog and a feeding area where the food is supplied.

16. The dog toilet according to claim 3, wherein in the bottom portion, a continuous concave groove is between an excretion area of the dog and a feeding area where the food is supplied.

17. The dog toilet according to claim 2, wherein
a liquid-absorbent absorbent member that absorbs urine is in the bottom portion, and
an area of a portion of the absorbent member on the other side in the front-rear direction is larger than an area of a portion of the absorbent member on the one side in the front-rear direction.

18. The dog toilet according to claim 3, wherein
a liquid-absorbent absorbent member that absorbs urine is in the bottom portion, and
an area of a portion of the absorbent member on the other side in the front-rear direction is larger than an area of a portion of the absorbent member on the one side in the front-rear direction.

19. The dog toilet according to claim 4, wherein
a liquid-absorbent absorbent member that absorbs urine is in the bottom portion, and
an area of a portion of the absorbent member on the other side in the front-rear direction is larger than an area of a portion of the absorbent member on the one side in the front-rear direction.

20. The dog toilet according to claim 5, wherein
a liquid-absorbent absorbent member that absorbs urine is in the bottom portion, and
an area of a portion of the absorbent member on the other side in the front-rear direction is larger than an area of a portion of the absorbent member on the one side in the front-rear direction.
